(19) United States
(12) Patent Application Publication
(10) Pub. No.: US 2012/0319594 A1
(43) Pub. Date: Dec. 20, 2012

(54) LIGHTING APPARATUS AND CONTROL METHOD THEREOF

(75) Inventor: Dong Min Ko, Seoul (KR)

(73) Assignee: Samsung Electronics., Ltd., Suwon-si (KR)

(21) Appl. No.: 13/443,958

(22) Filed: Apr. 11, 2012

(30) Foreign Application Priority Data
Jun. 15, 2011 (KR) 10-2011-0057809

(51) Int. Cl. H05B 37/02

(52) U.S. Cl. 315/152; 315/313

(57) ABSTRACT

A lighting apparatus includes a light source to generate light, a light emitting mode selection unit to select one light emitting mode from among a plurality of light emitting modes including a strobe light mode implemented by temporarily switching the light source on and a continuous light mode implemented by continuously switching the light source on, and a control unit to control switching-on of the light source to implement the light emitting mode selected through the light emitting mode selection unit. Therethrough, a plurality of lighting apparatuses can be connected, and each of the plurality of lighting apparatuses can be operated in independent light emitting modes, when the plurality of lighting apparatuses are connected, to produce various lighting environments.

### CROSS-REFERENCE TO RELATED APPLICATION

This application claims the benefit of Korean Patent Application No. 2011-0057809, filed on Jun. 15, 2011 in the Korean Intellectual Property Office, the disclosure of which is incorporated herein by reference in its entirety.

### BACKGROUND

1. Field

Embodiments relate to a lighting apparatus to take a photograph (or a moving image).

2. Description of the Related Art

Taking of a photograph (or a moving image) closely relates to light, and thus a desired image is not acquired in an environment in which a quantity of light is insufficient. If a quantity of light is insufficient, a lighting apparatus that artificially generates light is used to supplement the insufficient quantity of light. Lighting apparatuses are divided into an internal type and an external type. An internal type lighting apparatus is installed within a camera. An external type lighting apparatus is connected to a camera through a hot shoe and forms electrical contact through the connection to achieve communication with the camera.

External type lighting apparatuses which are recently used have a low degree of freedom in setting of a light emitting mode, thus being not easy to produce various types of lighting environments.

### SUMMARY

Therefore, it is an aspect to provide a lighting apparatus with at least one coupling unit through which the lighting apparatus can be connected to one other lighting apparatus to achieve communication between the plural lighting apparatuses through electrical contact by the connection.

It is another aspect to provide a lighting apparatus with at least one coupling through which the lighting apparatus can be connected to one other lighting apparatus to enable the plural lighting apparatuses to be operated in different light emitting modes to produce various lighting environments.

It is a further aspect to provide a lighting apparatus which increases a quantity of light through calibration, even if performance of a light source has deteriorated as the frequency of use of the lighting apparatus increases, to overcome decrease in the quantity of light due to deterioration in the performance of the light source.

Additional aspects will be set forth in part in the description which follows and, in part, will be obvious from the description, or may be learned by practice of the invention.

In accordance with one aspect, a lighting apparatus includes a light source to generate light, at least one coupling unit adapted to mechanically couple to one other lighting apparatus to enable the lighting apparatus to be used together with the other lighting apparatus, and a connector to form an electrical contact with the other lighting apparatus, wherein the lighting apparatus and the other lighting apparatus are used together through the connector or the at least one coupling unit.

The lighting apparatus may further include a light emitting mode selection unit to select one light emitting mode from among a plurality of light emitting modes including a strobe light mode and a continuous light mode, and a control unit to control operation of the light source in the light emitting mode selected through the light emitting mode selection unit.

The plurality of light emitting modes may further include an AF assistant light mode.

The lighting apparatus may further include a case forming an external appearance of the lighting apparatus, and the at least one coupling unit may be at a depth lower than a surface of the case so as not to protrude from the surface of the case.

The at least one coupling unit may be at least one hot shoe.

The light source may include LEDs.

In accordance with another aspect, a lighting apparatus includes a light source to generate light, a light emitting mode selection unit to select one light emitting mode from among a plurality of light emitting modes including a strobe light mode implemented by temporarily switching the light source on and a continuous light mode implemented by continuously switching the light source on, a communication unit to communicate with at least one other lighting apparatus, and a control unit to control switching-on of the light source to implement the light emitting mode selected through the light emitting mode selection unit, wherein, when the lighting apparatus is communicably connected to the at least one other lighting apparatus, the control unit implements the light emitting mode selected through the light emitting mode selection unit independently of a light emitting mode of the at least one other lighting apparatus.

The lighting apparatus may be synchronized with a camera through the communication unit.

The lighting apparatus may further include at least one from among a wireless communication cable terminal and a wireless communication antenna for communication through the communication unit.

The plurality of light emitting modes may further include an AF assistant light mode.

The light source may include LEDs.

In accordance with another aspect, a lighting apparatus includes a light source to generate light, a light emitting mode selection unit to select one light emitting mode from among a plurality of light emitting modes including a strobe light mode implemented by temporarily switching the light source on and a continuous light mode implemented by continuously switching the light source on, and a control unit to control the light source to implement the light emitting mode selected through the light emitting mode selection unit.

The lighting apparatus may further include a connector coupled with a hot shoe of a camera and forming an electrical contact to communicate with the camera.

The lighting apparatus may further include a first communication unit communicating with the camera through the electrical contact, and the control unit may be synchronized with the camera through the first communication unit.

The lighting apparatus may further include a second communication unit communicating with at least one from among a camera and one other lighting apparatus through at least one of a wired communication and a wireless communication, and the lighting apparatus may be synchronized with the at least one from among the camera and the other lighting apparatus through the second communication unit.

The plurality of light emitting modes may further include an AF assistant light mode.

The light source may include LEDs.

In accordance with another aspect, a lighting apparatus includes a light source to generate light, a calibration mode selection unit to select a calibration mode of the light source, and a control unit to acquire an exposure deviation between an exposure value of an image of a white subject photographed through emission of light from the light source and a predetermined reference exposure value, when the calibration mode is selected. The control unit adjusts a current supply control value of the light source to achieve calibration enabling the exposure value due to emission of light from the light source to coincide with the reference exposure value based on the exposure deviation.

The control unit may receive selection of the calibration mode through the calibration mode selection unit and guide generation of the photographed image of the white subject through emission of light from the light source, when the selection of the calibration mode is received.

The control unit may control a display unit to display a guide message guiding generation of the photographed image of the white subject.

The light source may include LEDs.

In the adjustment of the current supply control value of the light source, the current supply control value may be increased to achieve calibration of the light source when the exposure value of the photographed image is less than the predetermined reference exposure value.

In accordance with another aspect, a control method of a lighting apparatus which has a light source to generate light, a display unit to display operation information of the lighting apparatus, a calibration mode selection unit to select a calibration mode of the light source, and a control unit to control overall operation of the lighting apparatus, includes receiving selection of the calibration mode through the calibration mode selection unit, acquiring an exposure deviation between an exposure value of an image of a white subject photographed through emission of light from the light source and a predetermined reference exposure value, and adjusting a current supply control value of the light source to achieve calibration enabling the exposure value due to emission of light from the light source to coincide with the reference exposure value based on the exposure deviation.

The control method may further include guiding generation of the photographed image of the white subject through emission of light from the light source, when the selection of the calibration mode is received.

The control method may further include controlling the display unit to display a guide message guiding generation of the photographed image of the white subject.

The light source may include LEDs.

The adjustment of the current supply control value of the light source may include increasing the current supply control value to achieve calibration of the light source when the exposure value of the photographed image is less than the predetermined reference exposure value.

In accordance with another aspect, a lighting apparatus includes a light source to generate light and a coupling unit to connect the lighting apparatus to one other lighting apparatus, wherein a light emitting mode of the lighting apparatus is implemented through cooperation with the other lighting apparatus connected through the coupling unit or independently of the other lighting apparatus.

In accordance with yet another aspect, a lighting apparatus includes a light source to generate light, a connector coupled with one other lighting apparatus to form an electrical contact for communication with the other lighting apparatus, and a coupling unit to connect the lighting apparatus to the other lighting apparatus, wherein a light emitting mode of the lighting apparatus is implemented through cooperation with the other lighting apparatus connected through the coupling unit or independently of the other lighting apparatus.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating a lighting apparatus in accordance with one embodiment;

FIG. 2 is a view illustrating the structure of a light emitting unit of the lighting apparatus of FIG. 1;

FIG. 3 is a view illustrating a display unit and an operation unit provided on the rear surface of the lighting apparatus of FIG. 1;

FIGS. 4(A) to 4(F) are views illustrating a method of selecting one of light emitting modes of the lighting apparatus through the display unit and the operation unit of FIG. 3;

FIG. 5 is a view illustrating a control system of the lighting apparatus of FIG. 1;

FIGS. 6 and 7 are views illustrating use of a plurality of lighting apparatuses connected in accordance with another embodiment;

FIG. 8 is a view illustrating use of a plurality of lighting apparatuses connected in accordance with a further embodiment;

FIGS. 9 and 10 are views illustrating a calibration environment of a lighting apparatus in accordance with one embodiment; and

FIG. 11 is a view illustrating a calibration method of a lighting apparatus in accordance with one embodiment.

### DETAILED DESCRIPTION

Reference will now be made in detail to embodiments, examples of which are illustrated in the accompanying drawings, wherein like reference numerals refer to like elements throughout.

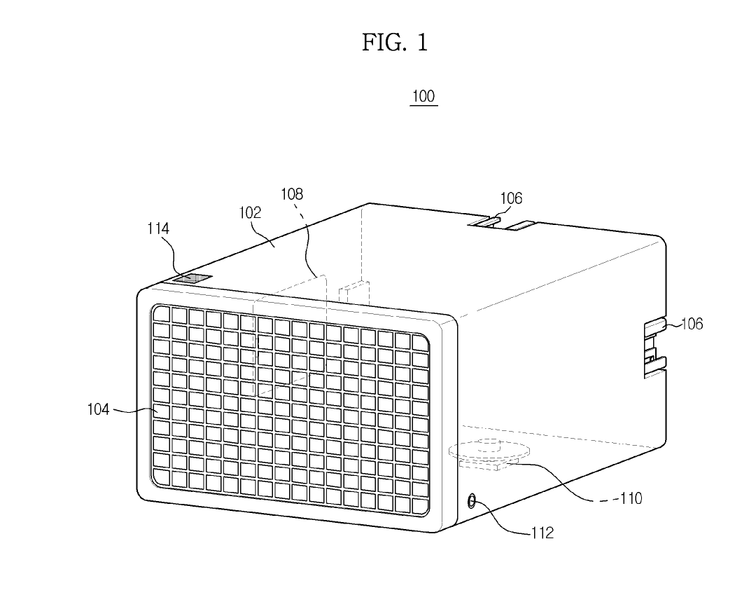

FIG. 1 is a view illustrating a lighting apparatus in accordance with one embodiment. As shown in FIG. 1, a lighting apparatus 100 in accordance with this embodiment can include a case 102 forming the external appearance of the lighting apparatus 100. A light emitting unit 104 can be provided on the front surface of the case 102, and hot shoes 106 can be respectively provided on the upper surface and the right and left surfaces of the case 102. The hot shoes 106 can serve as coupling units to connect other lighting apparatuses to the lighting apparatus 100 of FIG. 1. Electrical contacts can be formed by connection through the hot shoes 106, and communication between at least two lighting apparatuses, which are connected, can be carried out through the electrical contacts. Each hot shoe 106 may not protrude from the surface of the case 102 to prevent scratches on the lighting apparatuses due to the hot shoe 106. For this purpose, the hot shoe 106 can be buried at a depth lower than the surface of the case 102, i.e., equal to or below the surface of the case 102. Electrical devices necessary for control, communication and power supply can be provided within the case 102 of the lighting apparatus 100. A battery used as power of the lighting apparatus 100 can be accommodated within a battery accommodation space provided at the inside of a battery cover 108. A connector 110 can be provided at the lower portion of the case 102. The connector 110 can be coupled with a hot shoe of a camera, thereby connecting the camera and the lighting apparatus 100 to each other. Also, the connector 110 can be coupled with the hot shoe of the camera to provide communication between the camera and the lighting apparatus 100 through electrical contact formed by the connection therebetween. Further, at least two lighting apparatuses 100 having the structure of FIG. 1 may be connected through the hot shoes 106 and the connector 110. The lighting apparatus 100 can further include a wired communication cable terminal 112 and a wireless communication cable antenna 114. Electrical connection for communication between the lighting apparatus 100 and the camera and electrical connection for communication between the at least two lighting apparatuses 100 may be achieved thereby.

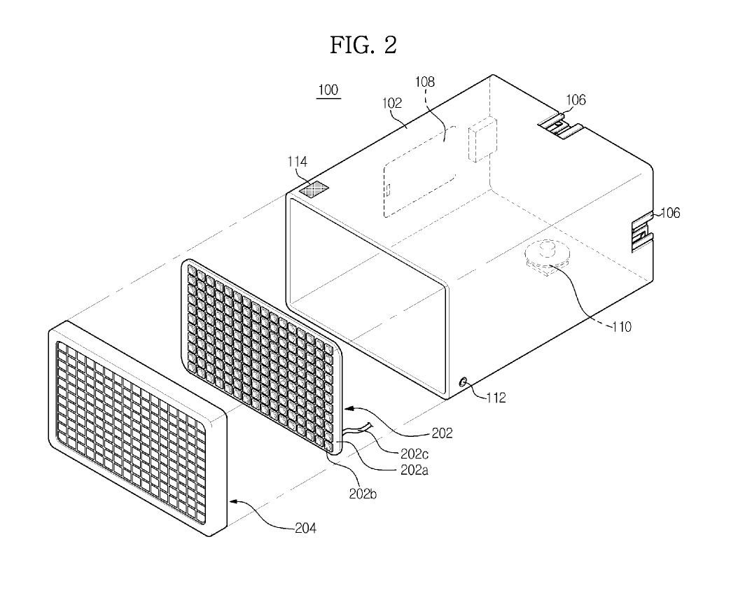

FIG. 2 is a view illustrating the structure of the light emitting unit of the lighting apparatus of FIG. 1. As shown in FIG. 2, a light source 202 and a transparent panel 204 can be provided at the inside of the front surface of the lighting apparatus 100. The light source 202 can be formed by electrically and mechanically connecting a plurality of LEDs 202b to a circuit board 202a. The circuit board 202a can receive power and a control signal through a cable 202c and then can drive the plurality of LEDs 202b. The transparent panel 204 can be installed in front of the light source 202. The transparent panel 204 can provide protection of the light source 202 and adjustment of a spreading range of light generated from the light source 202.

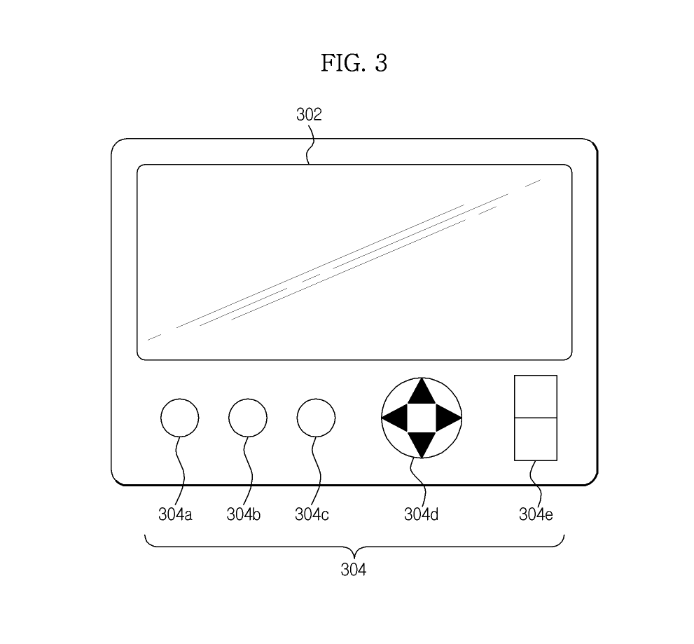

FIG. 3 is a view illustrating a display unit and an operation unit provided on the rear surface of the lighting apparatus 100 of FIG. 1. As shown in FIG. 3, a display unit 302 and an operation unit 304 can be provided on the rear surface of the lighting apparatus 100. The display unit 302 can include an LCD that can display operation information (a current stage, setting values, a guide message, etc.) of the lighting apparatus 100. The operation unit 304 can enable selection of one of a plurality of operation modes of the lighting apparatus 100 and can set or change various values necessary for respective operation modes. The operation unit 304 can include a mode selection button 304a, a side light selection button 304b, a calibration mode selection button 304c, a cross button 304d, and a power switch 304e. The mode selection button 304a can function as a light emitting mode selection unit and can serve to enable a user to select and set one from among different light emitting modes, such as an auto focus (AF) assistant light mode, a strobe light mode, a continuous light mode, etc. The side light selection button 304b can serve to enable the user to select one from among different side light modes, such as TTL, A-TTL, E-TTL, E-TTL2, etc. The calibration mode selection button 304c can serve to enable the user to select a calibration mode to calibrate brightness of the light source of the lighting apparatus 100. The cross button 304d can be used to change various setting values and to move items displayed on the display unit 302. The cross button 304d can include four arrow keys in the upward, downward, leftward and rightward directions and one selection key located at the center of the four arrow keys. The power switch 304e can be used to switch the lighting apparatus 100 on/off.

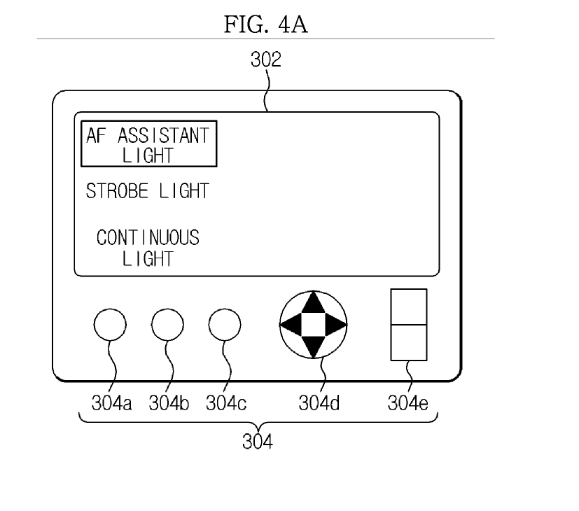

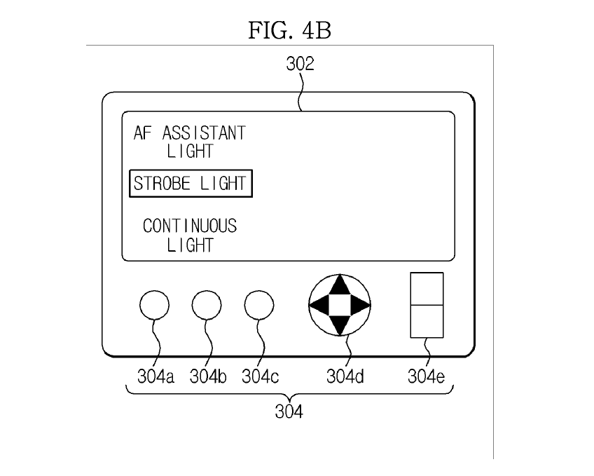

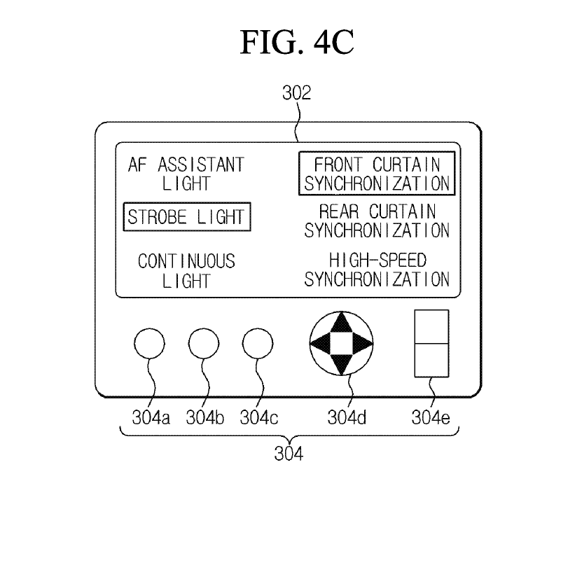

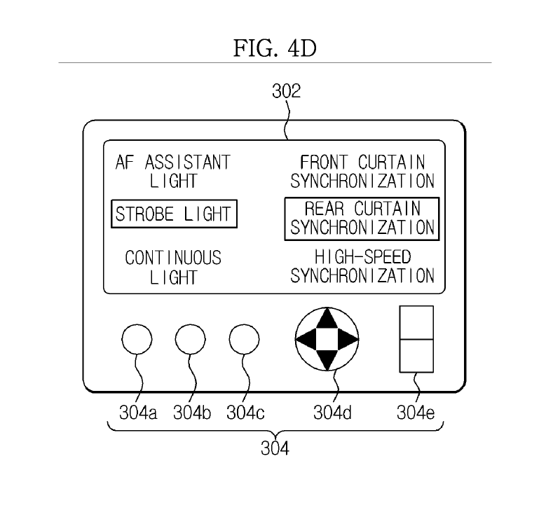

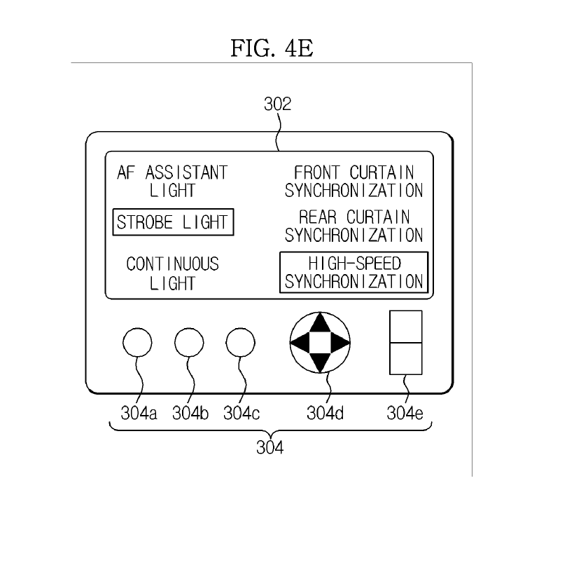

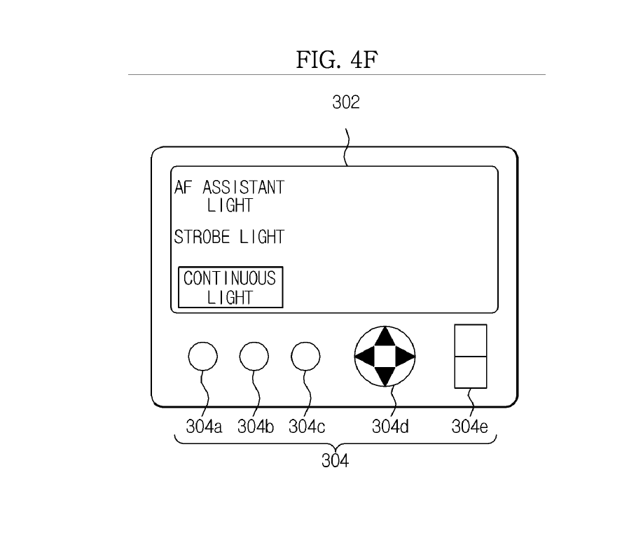

FIGS. 4(A) to 4(F) are views illustrating a method of selecting one of the light emitting modes of the lighting apparatus 100 through the display unit 302 and the operation unit 304 of FIG. 3. First, as shown in FIG. 4(A), a user can operate the mode selection button 304a to display a selection menu that can include an AF assistant light mode, a strobe light mode and a continuous light mode on the display unit 302. The user may select a desired one mode from among the three displayed modes by moving a highlight by operating the upward/downward keys of the cross button 304d.

The AF assistant light mode can be an operation mode that can enable the lighting apparatus 100 to project a designated quantity of light onto a subject to be focused upon under a photographing environment in which light is insufficient or during photographing at night, when a camera is operated in an auto focus mode. The strobe light mode can be a light emitting mode implemented by momentarily switching the light source 202 on and can be implemented for a relatively short period of time in synchronization with a point of shutter release time. The continuous light mode can be a light emitting mode in which the on state of the light source 202 can be maintained for a relatively long time. In the continuous light mode, the light source 202 can generally be switched on regardless of the point of shutter release time, but switching-on/off of the light source 202 may be controlled in synchronization with the point of shutter release time, as needed.

When the user selects the AF assistant light mode, the light source 202 can be switched on so as to assure a quantity of light necessary for focusing when a shutter release button of the camera is in a shutter half-pressing state for focusing.

When the user selects the strobe light mode, as shown in FIG. 4(B), a lower-level menu including front curtain synchronization, rear curtain synchronization, and high-speed synchronization can be displayed. The user can select one from among front curtain synchronization, rear curtain synchronization, and high-speed synchronization by operating the direction selection keys of the cross button 304d, as shown in FIGS. 4(C)-(E). Front curtain synchronization can be a method in which, when photographing is achieved using a camera having a shutter including a front curtain and a rear curtain, light can be momentarily emitted in synchronization with a point of time when the front curtain is opened. In front curtain synchronization, the lighting apparatus can momentarily emit light at the point of time when the shutter is opened and photographs a subject, and then movement of the subject remains as an after image until the shutter is closed. Rear curtain synchronization can be a method in which, when a photographing is achieved using the camera having the shutter including the front curtain and the rear curtain, light can be momentarily emitted in synchronization with a point of time when the rear curtain is closed. In rear curtain synchronization, movement of a subject after the shutter is opened can remain as an after image, and then the lighting apparatus can momentarily emit light at a point of time when the shutter is closed and can photograph the subject. High-speed synchronization can be an operation mode in which the lighting apparatus can emit light for a short period of time when the front curtain of the shutter is opened and the rear curtain of the shutter is closed, if the speed of the shutter is exceeds a designated value (generally, 1/200^{th} of a second).

When the user selects the continuous light mode, as shown in FIG. 4(F), the on state of the light source 202 can be maintained so as to continuously assure a quantity of light for a relatively long time.

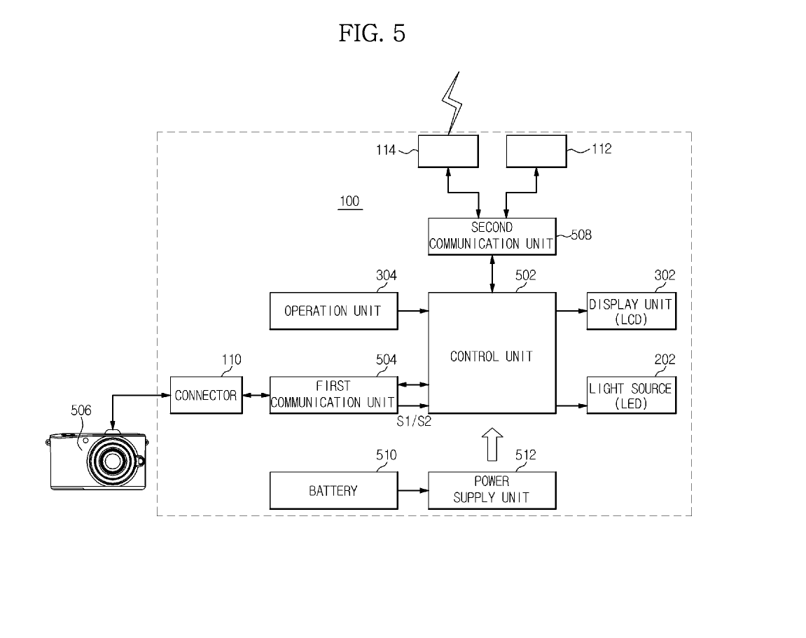

FIG. 5 is a view illustrating a control system of the lighting apparatus 100 of FIG. 1. As shown in FIG. 5, a control unit 502 that can control the overall operation of the lighting apparatus 100 can communicate with a camera 506 through a first communication unit 504. The first communication unit 504 can be communicably connected to the camera 506 through contact formed by connecting the connector 110, as described with reference to FIG. 1, to a hot shoe of the camera 506. The control unit 502 can receive a control signal from the camera 506 and can transmit a necessary response signal to the camera 506 through communication with the camera 506 through the first communication unit 504. For example, if the lighting apparatus 100 is used as AF assistant light and front curtain synchronization, rear curtain synchronization or high-speed synchronization is set as the operation mode of the lighting apparatus 100, a shutter release signal S1/S2 supplied from the camera 506 can be transmitted to the control unit 502 of the lighting apparatus 100 through the first communication unit 504, and the control unit 502 can control a point of time when the light source 202 is switched on and a quantity of light in response to the shutter release signal S1/S2.

Further, the control unit 502 can communicate with the outside through a second communication unit 508. That is, the control unit 502 can communicate with one other external camera or one other lighting apparatus through the second communication unit 508. For example, if wired/wireless synchronization relations between the lighting apparatus 100 of FIG. 1 and one other lighting apparatus are set, the control unit 502 can transmit a synchronization signal to the other lighting apparatus through the second communication unit 508, and the other lighting apparatus can receive the synchronization signal and can emit light in response to the synchronization signal. Communication through the second communication unit 508 can be achieved through cooperation with the wired communication cable terminal 112 and the wireless communication antenna 114 of FIG. 1.

Further, the control unit 502 can receive a selection signal or a setting signal generated from the operation unit 304 and can control operation of the lighting apparatus 100 corresponding to the received signal.

Power of the lighting apparatus 100 can be supplied from the battery 510. A power supply unit 512 can convert power supplied from the battery 510 into power having intensities required by respective components of the lighting apparatus 100, and can then supply the converted power to the respective components of the lighting apparatus 100.

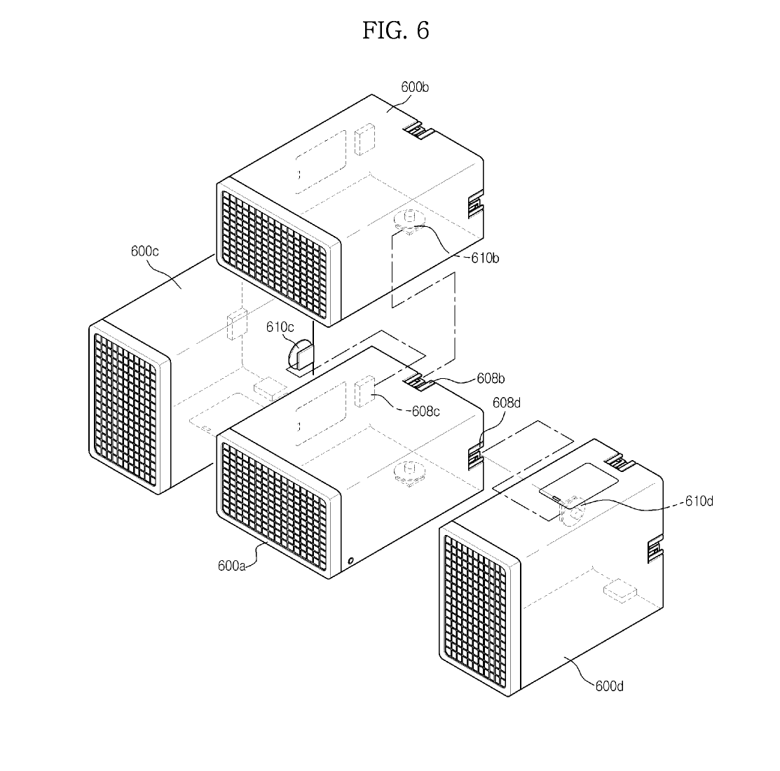

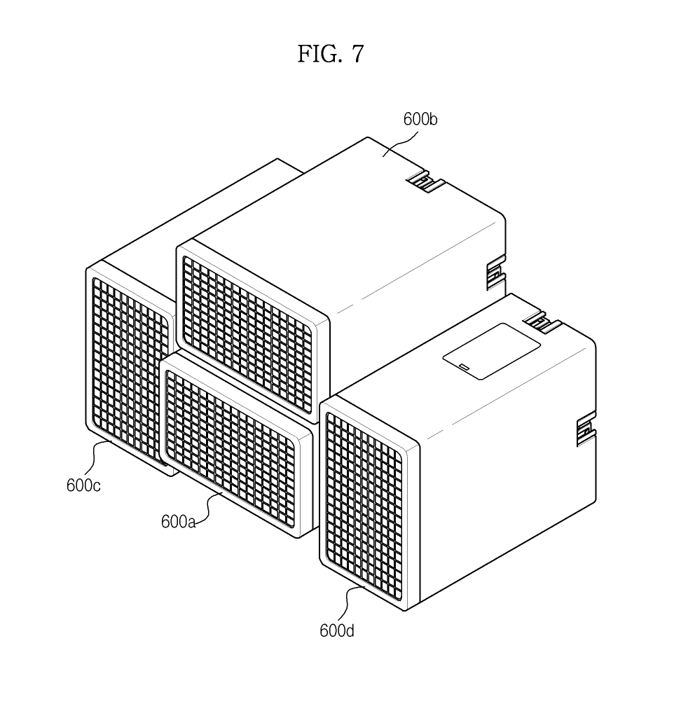

FIGS. 6 and 7 are views illustrating use of a plurality of lighting apparatuses connected in accordance with another embodiment. First, as shown in FIG. 6, a second lighting apparatus 600b can be connected to a first lighting apparatus 600a by coupling a connector 610b of the second lighting apparatus 600b with a hot shoe 608b provided on the upper surface of the first lighting apparatus 600a; a third lighting apparatus 600c can be connected to the first lighting apparatus 600a by coupling a connector 610c of the third lighting apparatus 600c with a hot shoe 608c provided on the right surface of the first lighting apparatus 600a; and a fourth lighting apparatus 600d can be connected to the first lighting apparatus 600a by coupling a connector 610d of the fourth lighting apparatus 600d with a hot shoe 608d provided on the left surface of the first lighting apparatus 600a.

FIG. 7 is a view illustrating the four lighting apparatuses 600a, 600b, 600c and 600d in the connected state. At least one additional lighting apparatus can be connected to the first lighting apparatus 600a through the connection shown in FIG. 7, thereby providing following effects.

First, at least two lighting apparatuses can be connected and used, thereby assuring a quantity of light necessary for a photographing condition requiring a large quantity of light. For example, a sufficient quantity of light can be assured in a dark indoor space having an excessively insufficient quantity of light or at night, and thus, proper exposure can be executed, thereby enabling a photograph having a desirably high quality to be taken.

Second, the at least two lighting apparatuses can be connected, and the respective lighting apparatuses can be operated in different light emitting modes required for photographing, thereby producing various photographing conditions. For example, photographing may be achieved while using the first lighting apparatus 600a as a key light, the second lighting apparatus 600b and the third lighting apparatus 600c as fill lights, and the fourth lighting apparatus 600d as an AF assistant light. For this purpose, a user can individually set desired light emitting modes of the four lighting apparatuses 600a, 600b, 600c and 600d, and can independently operate the respective lighting apparatuses 600a, 600b, 600c and 600d in the set light emitting modes during actual photographing.

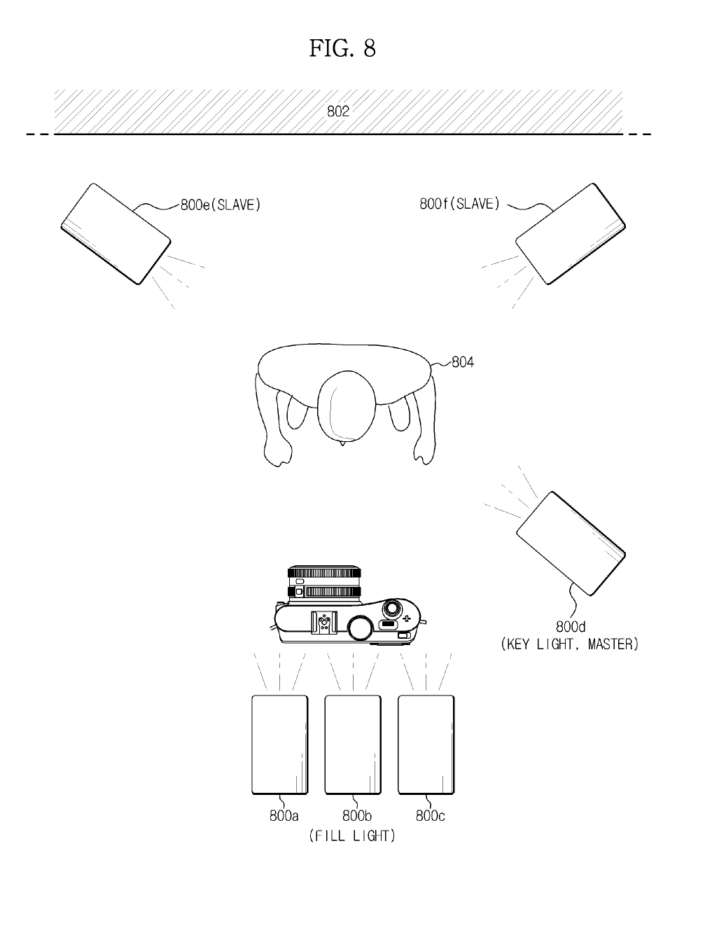

FIG. 8 is a view illustrating use of a plurality of lighting apparatuses connected in accordance with a further embodiment. As shown in FIG. 8, a plurality of lighting apparatuses 800a, 800b, 800c, 800d, 800e and 800f can be disposed at desired positions within a photographing space, thereby producing various photographing conditions. For example, the first, second, and third lighting apparatuses 800a, 800b and 800c can be used as fill lights to light surroundings of a subject 804 standing in front of a background 802. Here, the first to third lighting apparatuses 800a, 800b and 800c can be communicably connected to form one group. The fourth lighting apparatus 800d can be used as a key light to light the subject 804 during actual photographing. The fifth lighting apparatus 800e can be used as a light to form the highlight at the edge of the subject 804. The sixth lighting apparatus 800f can be used as a light to light the hair of the subject 804. As needed, the fourth lighting apparatus 800d serving as the key light may be set as a master, and the fifth and sixth lighting apparatuses 800e and 800f may be set as slaves so that, when the fourth lighting apparatus 800d is switched on, the fifth and sixth lighting apparatuses 800e and 800f can be switched on in synchronization with switching-on of the fourth lighting apparatus 800d.

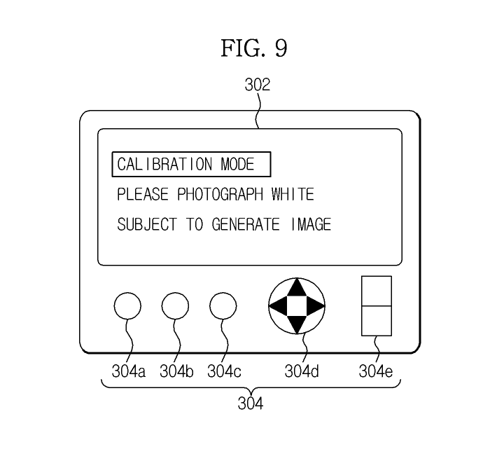

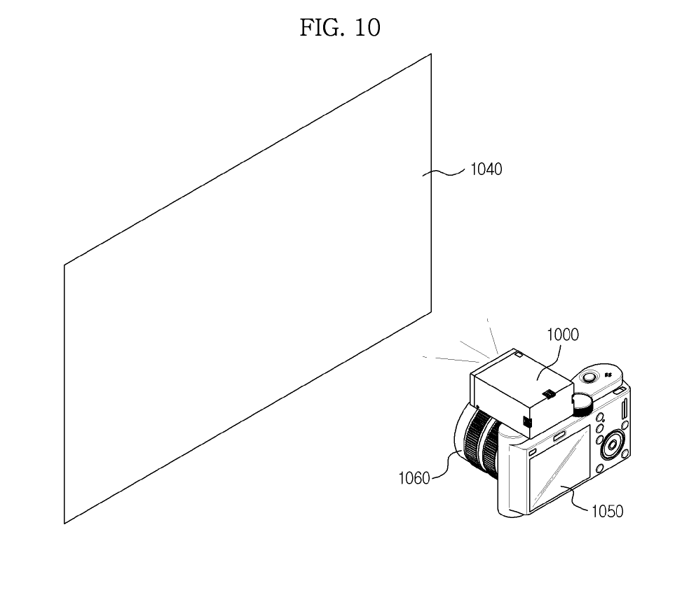

FIGS. 9 and 10 are views illustrating a calibration environment of a lighting apparatus in accordance with one embodiment. ‘Calibration of the lighting apparatus’ can increase a quantity of light even if performance of the light source of the lighting apparatus is deteriorated and a quantity of emitted light is decreased, thereby overcoming decrease in the quantity of emitted light due to deterioration in the performance of the light source. FIG. 9 illustrates a guide message that can be displayed on the display unit 302 when the calibration mode is selected through the calibration mode selection button 304c of the operation unit 304 provided on the rear surface of a lighting apparatus 1000. FIG. 10 illustrates a photographing condition for calibration. As shown in FIG. 10, in order to achieve calibration of the lighting apparatus 1000 in accordance with this embodiment, photographing can be carried out while adjusting an angle of view of a lens 1060 in the calibration mode of the lighting apparatus 1000 so that a white subject (for example, a sheet of paper or a wall surface) 1040 fully fills a view finder of a camera 1050 and emitting light toward the white subject 1040 from the lighting apparatus 1000. Instead of the white subject 1040, a gray card may be used. The camera 1050 and the lighting apparatus 1000 may be directly connected through a hot shoe or may be connected through wired communication or wireless communication. If the camera 1050 and the lighting apparatus 1000 are connected through wired communication or wireless communication, the camera 1050 and the lighting apparatus 1000 can be preferably located at a distance by which light emitted from the lighting apparatus 1000 may directly influence an image photographed by the camera 1050.

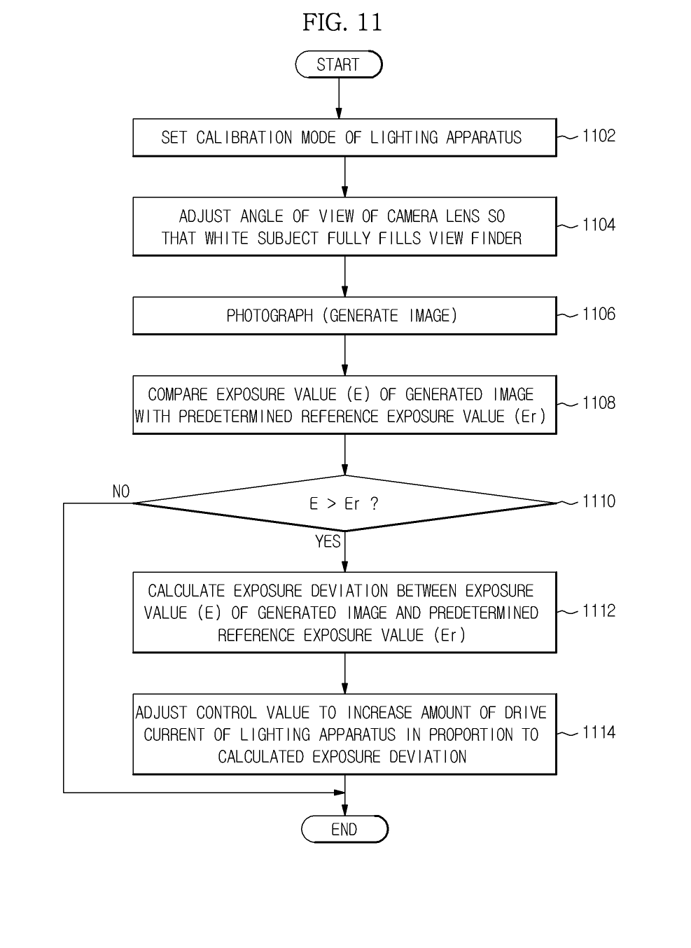

FIG. 11 is a view illustrating a calibration method of a lighting apparatus in accordance with one embodiment. The calibration method shown in FIG. 11 can be preferably executed in the calibration environment shown in FIG. 10. As shown in FIG. 11, under the condition that the camera 1050 provided with the lens 1060 and the lighting apparatus 1000 are switched on, the calibration mode of the lighting apparatus 1000 can be set (Operation 1102). An angle of view (a focal distance) of the lens 1060 can be adjusted so that the white subject 1040 fully fills the view finder of the camera 1050 (i.e., an image formed by photographing is expressed in white) when a user watches the subject 1040 through the view finder (Operation 1104). In this state, the subject 1040 can be photographed (Operation 1106). Such an image formed by photographing can be stored in a memory of the camera (digital camera) 1050. When photographing of the white subject 1040 has been completed, an exposure value E of the formed image can be compared with a predetermined reference exposure value Er (Operation 1108). The conventional reference exposure value Er can mean a degree of exposure of an image when the lighting apparatus 1000 emits light at an excellent quantity exceeding a designated value. Here, since the excellent quantity of light exceeding the designated value may be varied according to photographing conditions and there is an exposure value judged to be proper in a specific photographing condition, various photographing conditions can be preferably set in consideration of the above facts, and proper exposure values corresponding to the set photographing conditions can be preferably determined and set as the reference exposure value. As the lighting apparatus 1000 is continuously used, mechanical/electrical fatigue of LEDs used as a light source may increase, and a quantity of light emitted from the LEDs may be reduced. Therefore, by calibrating the quantity of light emitted from the lighting apparatuses 1000 based on the reference exposure value Er, the lighting apparatus 1000 may emit light at the above-described excellent quantity exceeding the designated value even if the lighting apparatus 1000 is continuously used. When the exposure value E of the formed image is less than the predetermined reference exposure value Er (Yes in Operation 1110), it can be judged that the performance (the quantity of light) of the lighting apparatus 1000 is lowered, and a deviation between the exposure value E of the formed image and the predetermined reference exposure value Er can be calculated (Operation 1112). On the other hand, when the exposure value E of the formed image is not less than the predetermined reference exposure value Er (No in Operation 1110), it can be judged that calibration of the lighting apparatus 1000 is unnecessary, and the process can be ended. When the exposure value E of the formed image is less than the predetermined reference exposure value Er (Yes in Operation 1110), a control value can be adjusted so that an amount of drive current of the lighting apparatus 1000 increases in proportion to the calculated exposure deviation (Operation 1114). Through such adjustment, a quantity of light emitted from the light source can be increased, and an exposure value of the image due to the increased quantity of light emitted from the light source can be improved to coincide with the reference exposure value.

As is apparent from the above description, a lighting apparatus in accordance with one embodiment can be provided with at least one coupling unit through which the lighting apparatus is connected to one other lighting apparatus to achieve communication between the plural lighting apparatuses through electrical contact by the connection.

Further, the lighting apparatus in accordance with an embodiment with the at least one coupling unit through which the lighting apparatus is connected to the other lighting apparatus can enable the plural lighting apparatuses to be operated in different light emitting modes, thereby producing various lighting environments.

Moreover, the lighting apparatus in accordance with an embodiment can increase a quantity of light through calibration, even if performance of a light source has deteriorated as the frequency of use of the lighting apparatus increases, thereby overcoming decrease in the quantity of light due to deterioration in the performance of the light source.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. It will also be recognized that the terms “comprises,” “comprising,” “includes,” “including,” “has,” and “having,” as used herein, are specifically intended to be read as open-ended terms of art. The words “mechanism” and “element” are used broadly and are not limited to mechanical or physical embodiments, but may include software routines in conjunction with processors, etc. No item or component is essential to the practice of the invention unless the element is specifically described as “essential” or “critical”. Furthermore, recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. Finally, the steps of all methods described herein can be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Also, the invention may employ any number of conventional techniques for electronics configuration, signal processing and/or control, data processing and the like. The apparatus described herein may comprise a processor, a memory for storing program data to be executed by the processor, a permanent storage such as a disk drive, a communications port for handling communications with external devices, and user interface devices, including a display, keys, etc.

Embodiments may be embodied as computer-readable code in a computer-readable recording medium. The computer-readable recording medium may be any recording apparatus capable of storing data that is read by a computer system.

The computer-readable code may be embodied in such a manner that a control method of a lighting apparatus, according to the present invention, may be performed when the computer-readable code is read and executed by a processor. The computer-readable code may be written in various programming languages.

When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. Where elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Also, using the disclosure herein, programmers of ordinary skill in the art to which the invention pertains can easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Functional aspects may be implemented in algorithms that execute on one or more processors. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

Although a few embodiments have been shown and described, it would be appreciated by those skilled in the art that changes may be made in these embodiments without departing from the principles and spirit of the invention, the scope of which is defined in the claims and their equivalents. Therefore, the scope of the invention is defined not by the detailed description of the invention but by the following claims, and all differences within the scope will be construed as being included in the invention.

What is claimed is:

1. A lighting apparatus comprising:
a light source to generate light;
at least one coupling unit adapted to mechanically couple to one other lighting apparatus to enable the lighting apparatus to be used together with the other lighting apparatus; and
a connector to form an electrical contact with the other lighting apparatus, wherein the lighting apparatus and the other lighting apparatus are used together through the connector or the at least one coupling unit.

2. The lighting apparatus according to claim 1, further comprising:
a light emitting mode selection unit to select one light emitting mode from among a plurality of light emitting modes including a strobe light mode and a continuous light mode; and
a control unit to control operation of the light source in the light emitting mode selected through the light emitting mode selection unit.

3. The lighting apparatus according to claim 2, wherein the plurality of light emitting modes further includes an AF assistant light mode.

4. The lighting apparatus according to claim 1, further comprising a case forming an external appearance of the lighting apparatus,
wherein the at least one coupling unit is at a depth lower than a surface of the case so as not to protrude from the surface of the case.

5. The lighting apparatus according to claim 1, wherein the at least one coupling unit is at least one hot shoe.

6. The lighting apparatus according to claim 1, wherein the light source includes LEDs.

7. A lighting apparatus comprising:
a light source to generate light;
a light emitting mode selection unit to select one light emitting mode from among a plurality of light emitting modes including a strobe light mode implemented by temporarily switching the light source on and a continuous light mode implemented by continuously switching the light source on;
a communication unit to communicate with at least one other lighting apparatus; and
a control unit to control switching-on of the light source to implement the light emitting mode selected through the light emitting mode selection unit,
wherein, when the lighting apparatus is communicably connected to the at least one other lighting apparatus, the control unit implements the light emitting mode selected through the light emitting mode selection unit independently of a light emitting mode of the at least one other lighting apparatus.

8. The lighting apparatus according to claim 7, wherein the lighting apparatus is synchronized with a camera through the communication unit.

9. The lighting apparatus according to claim 7, further comprising at least one from among a wireless communication cable terminal and a wireless communication antenna for communication through the communication unit.

10. The lighting apparatus according to claim 7, wherein the plurality of light emitting modes further includes an AF assistant light mode.

11. The lighting apparatus according to claim 7, wherein the light source includes LEDs.

12. A lighting apparatus comprising:
a light source to generate light;
a light emitting mode selection unit to select one light emitting mode from among a plurality of light emitting modes including a strobe light mode implemented by temporarily switching the light source on and a continuous light mode implemented by continuously switching the light source on; and
a control unit to control the light source to implement the light emitting mode selected through the light emitting mode selection unit.

13. The lighting apparatus according to claim 12, further comprising a connector coupled with a hot shoe of a camera and forming an electrical contact to communicate with the camera.

14. The lighting apparatus according to claim 13, further comprising a first communication unit communicating with the camera through the electrical contact,
wherein the control unit is synchronized with the camera through the first communication unit.

15. The lighting apparatus according to claim 12, further comprising a second communication unit communicating with at least one from among a camera and one other lighting apparatus through at least one of a wired communication and a wireless communication,
wherein the lighting apparatus is synchronized with the at least one from among the camera and the other lighting apparatus through the second communication unit.

16. The lighting apparatus according to claim 12, wherein the plurality of light emitting modes further includes an AF assistant light mode.

17. The lighting apparatus according to claim 12, wherein the light source includes LEDs.

18. A lighting apparatus comprising:
a light source to generate light;
a calibration mode selection unit to select a calibration mode of the light source; and
a control unit to acquire an exposure deviation between an exposure value of an image of a white subject photographed through emission of light from the light source and a predetermined reference exposure value, when the calibration mode is selected, the control unit adjusting a current supply control value of the light source to achieve calibration enabling the exposure value due to emission of light from the light source to coincide with the reference exposure value based on the exposure deviation.

19. The lighting apparatus according to claim 18, wherein the control unit receives selection of the calibration mode through the calibration mode selection unit and guides generation of the photographed image of the white subject through emission of light from the light source, when the selection of the calibration mode is received.

20. The lighting apparatus according to claim 18, wherein the control unit controls a display unit to display a guide message guiding generation of the photographed image of the white subject.

21. The lighting apparatus according to claim 18, wherein the light source includes LEDs.

22. The lighting apparatus according to claim 18, wherein in the adjustment of the current supply control value of the light source, the current supply control value is increased to achieve calibration of the light source when the exposure value of the photographed image is less than the predetermined reference exposure value.

23. A control method of a lighting apparatus which has a light source to generate light, a display unit to display operation information of the lighting apparatus, a calibration mode selection unit to select a calibration mode of the light source, and a control unit to control overall operation of the lighting apparatus, the control method comprising:
receiving selection of the calibration mode through the calibration mode selection unit;
acquiring an exposure deviation between an exposure value of an image of a white subject photographed through emission of light from the light source and a predetermined reference exposure value; and
adjusting a current supply control value of the light source to achieve calibration enabling the exposure value due to emission of light from the light source to coincide with the reference exposure value based on the exposure deviation.

24. The control method according to claim 23, further comprising guiding generation of the photographed image of the white subject through emission of light from the light source, when the selection of the calibration mode is received.

25. The control method according to claim 24, further comprising controlling the display unit to display a guide message guiding generation of the photographed image of the white subject.

26. The control method according to claim 23, wherein the light source includes LEDs.

27. The control method according to claim 23, wherein the adjustment of the current supply control value of the light source includes increasing the current supply control value to achieve calibration of the light source when the exposure value of the photographed image is less than the predetermined reference exposure value.

28. A lighting apparatus comprising:
a light source to generate light; and
a coupling unit to connect the lighting apparatus to one other lighting apparatus,
wherein a light emitting mode of the lighting apparatus is implemented through cooperation with the other lighting apparatus connected through the coupling unit or independently of the other lighting apparatus.

29. A lighting apparatus comprising:
a light source to generate light;
a connector coupled with one other lighting apparatus to form an electrical contact for communication with the other lighting apparatus; and
a coupling unit to connect the lighting apparatus to the other lighting apparatus,
wherein a light emitting mode of the lighting apparatus is implemented through cooperation with the other lighting apparatus connected through the coupling unit or independently of the other lighting apparatus.
